(19) United States
(12) Patent Application Publication
(10) Pub. No.: US 2025/0317224 A1
(43) Pub. Date: Oct. 9, 2025

(54) SYSTEM AND METHOD FOR GENERATING A PATH LOSS PROPAGATION MODEL THROUGH MACHINE LEARNING

(71) Applicant: JIO PLATFORMS LIMITED, Ahmedabad (IN)

(72) Inventors: Brijesh lshvarlal SHAH, Navi Mumbai (IN); Amrish BANSAL, Navi Mumbai (IN); Sourav RAJ, Dombivli (IN); Nitesh Kumar CHOURASIA, Dombivli East (IN); Mayank Kumar TARAN, Dombivali East (IN); Anupkumar PANDEY, Dombivli East, (IN); Supriya BARKUL, Navi Mumbai (IN)

(73) Assignee: JIO PLATFORMS LIMITED, Ahmedabad (IN)

(21) Appl. No.: 18/873,144

(22) PCT Filed: Jun. 30, 2023
(86) PCT No.: PCT/IB2023/056831

§ 371 Date: Dec. 9, 2024

(30) Foreign Application Priority Data
Jun. 30, 2022 (IN) 202221037833

(51) Int. Cl. H04B 17/318; H04L 41/16; H04W 4/02

(52) U.S. Cl. CPC H04B 17/328; H04L 41/16; H04W 4/025

(57) ABSTRACT

The present disclosure provides a system and a method for generating a path loss propagation model through machine learning. The system generates a path loss propagation model for fifth generation (5G) networks for network planning. The path loss model predicts a reference signal received power/signal to noise interference ratio (RSRP/SINR) by leveraging a fourth generation (4G) user data.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for generating reference signal received power (RSRP) prediction models in a wireless telecommunication systems. More particularly, the present disclosure relates to a system and a method for generating a path loss propagation model through machine learning.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In any wireless network, information from path loss propagation models is required for network planning and consequently to provide an optimal service to end users. With the development and deployment of the fifth generation (5G) mobile communication system, new path loss models with high accuracy are required.

Conventionally, path loss prediction models have been built based on empirical or deterministic methods. The parameters of empirical models are extracted from drive test data. The drive test is a time-consuming and expensive process as multiple iterations of drive tests are required to acquire accurate and realiable data.

In deterministic models, such as ray tracing, use radio-wave propagation mechanisms and numerical analysis techniques for modeling computational electromagnetics. However, due to the lack of computational efficiency and prohibitive computation time in real environments, deterministic models may be difficult to implement.

Moreover, mechanisms of electromagnetic wave propagation in a wireless telecommunication system is diverse and may be generally classified as reflection, diffraction, and scattering. The complex propagation environment makes the prediction of a received signal strength difficult.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that provides an intelligent and robust system for path loss propagation in case of a fifth generation (5G) network which will predict a reference signal received power (RSRP) by leveraging an actual fourth generation (4G) user data instead of 5G drive test data.

It is an object of the present disclosure to provide a system and a method that uses a machine learning method to simulate the RSRP and an error correcting model for accurate predictions.

It is an object of the present disclosure to provide a system and a method that uses actual user data, which is more accurate compared to the drive test data for prediction resulting in an improved accuracy.

It is an object of the present disclosure to provide a system and a method that uutilizes an optimized architecture of Artificial Neural Network (ANN) models which generates highly accurate performance metrics and provides flexibility compared to traditional methods.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for estimating a path loss propagation model. The system includes a processor, and a memory operatively coupled to the processor, where the memory stores instructions to be executed by the processor. The processor receives one or more data parameters associated with a primary network. The one or more data parameters are based on a network configuration of the primary network. The processor predicts via a trained learning model a reference signal received power (RSRP) associated with the primary network based on the one or more data parameters. The trained learning model is based on a trained secondary network model. The processor receives one or more user parameters, where the one or more user parameters are based on an actual RSRP received from a computing device connected to the primary network. The processor generates via an error correction model an error estimation based on the predicted RSRP and the actual RSRP. The processor determines an estimated RSRP associated with the primary network based on the error estimation.

In an embodiment, the one or more data parameters may include at least one of a frequency, one or more physical parameters, and an antenna pattern associated with the primary network.

In an embodiment, the processor may use a Naïve RSRP prediction technique to predict the RSRP via the trained learning model.

In an embodiment, the one or more user parameters received by the processor may include at least one of a label switch router (LSR) data, a Latitude data, a Longitude data, one or more radio frequency parameters, and a device configuration data.

In an embodiment, the processor may generate an optimized model via the error correction model. The optimized model may be based on a variance between the predicted RSRP and the actual RSRP.

In an embodiment, the processor may use a Random Forest technique to generate the error estimation via the error correction model.

In an embodiment, the trained secondary network model used by the processor may be configured to receive one or more secondary data parameters associated with a secondary network. The one or more secondary data parameters may be based on a network configuration for the secondary network. The trained secondary network model may predict via a secondary learning model a RSRP associated with the secondary network based on the one or more secondary data parameters. The trained secondary network model may receive one or more secondary user parameters. The one or more secondary user parameters may be based on an actual RSRP received from a computing device connected to the secondary network. The trained secondary network model may determine an average RSRP based on the received one or more secondary user parameters and one or more predetermined geographical frameworks associated with a computing device connected to the secondary network. The trained secondary network model may identify one or more computing devices among the one or more predetermined geographical frameworks connected to the secondary network. The trained secondary network model may generate a total average RSRP based on the average RSRP and a RSRP associated with the identified one or more computing devices. The trained secondary network model may generate via a machine learning technique, a secondary error correction model based on the total average RSRP and the predicted RSRP.

In an embodiment, the secondary error correction model may be configured to receive the one or more secondary user parameters and generate an activation function to compute a measured RSRP based on the one or more secondary user parameters and the total average RSRP. The secondary error correction model may compute the activation function using an average regularized gradient such that a difference between the predicted RSRP and the measured RSRP is zero.

In an embodiment, the machine learning technique may be an Artificial Neural Network (ANN) technique.

In an embodiment, the one or more predetermined geographical frameworks may include at least a geographical area associated with the another computing device and a topography mapping associated with said at least geographical area.

In an aspect, the present disclosure relates to a method for estimating a path loss propagation model. The method includes receiving, by a processor associated with a system, one or more data parameters associated with a primary network. The one or more data parameters may be based on a network configuration of the primary network. The method includes predicting, by the processor, via a trained learning model a RSRP associated with the primary network based on the one or more data parameters. The trained learning model is based on a trained secondary network model. The method includes receiving, by the processor, one or more user parameters. The one or more user parameters are based on an actual RSRP received from a computing device connected to the primary network. The method includes generating, by the processor, via an error correction model, an error estimation based on the predicted RSRP and the actual RSRP. The method includes determining, by the processor, an estimated RSRP associated with the primary network based on the error estimation.

In an embodiment, the method may include receiving, by the processor, the one or more data parameters that may include at least one of: a frequency, one or more physical parameters, and an antenna pattern associated with the primary network.

In an embodiment, the method may include using, by the processor, a Naïve RSRP prediction technique for predicting the RSRP via the trained learning model.

In an embodiment, the method may include receiving, by the processor, the one or more user parameters that may include at least one of a label switch router (LSR) data, a Latitude data, a Longitude data, one or more radio frequency parameters, and a device configuration data.

In an embodiment, the method may include generating, by the processor, via the error correction model an optimized model. The optimized model may be based on a variance between the predicted RSRP and the actual RSRP.

In an embodiment, the method may include using, by the processor, a Random Forest technique to generate the error estimation via the error correction model.

In an aspect, a non-transitory computer readable medium includes a processor with executable instructions that cause the processor to receive one or more data parameters associated with a primary network. The one or more data parameters may be based on a network configuration of the primary network. The processor predicts via a trained learning model a RSRP associated with the primary network based on the one or more data parameters. The trained learning model is based on a trained secondary network model. The processor receives one or more user parameters. The one or more user parameters are based on an actual RSRP received from a computing device connected to the primary network. The processor generates via an error correction model an error estimation based on the predicted RSRP and the actual RSRP. The processor determines an estimated RSRP associated with the primary network based on the error estimation.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram (200) of a proposed system (108), in accordance with an embodiment of the present disclosure.

FIG. 3 illustrates an example closed loop workflow (300) for a pathloss prediction model, in accordance with an embodiment of the present disclosure.

FIG. 4 illustrates an example architecture (400) of the closed loop workflow, in accordance with an embodiment of the present disclosure.

FIG. 5 illustrates an example fifth generation (5G) prediction workflow diagram (500), in accordance with an embodiment of the present disclosure.

FIG. 6 illustrates an example average reference signal received power (RSRP) estimation (600) based on neighbouring cells within a grid, in accordance with an embodiment of the present disclosure.

FIG. 7 illustrates an example assignment (700) of cell identifications within the grid, in accordance with an embodiment of the present disclosure.

FIG. 8 illustrates an example diagram (800) based on a local zone factor, in accordance with an embodiment of the present disclosure.

FIGS. 9A-9C illustrate example methods (900A, 900B, 900C) for calculating a diffraction loss within the grid, in accordance with embodiments of the present disclosure.

FIG. 10 illustrates an example path loss model training (1000) using an Artificial Neural Network (ANN) technique, in accordance with an embodiment of the present disclosure.

FIG. 11 illustrates an example forward propagation (1100) for the path loss model, in accordance with an embodiment of the present disclosure.

FIG. 12 illustrates an example backward propagation (1200) for the path loss model, in accordance with an embodiment of the present disclosure.

FIG. 13 illustrates an example training (1300) of the designed ANN model, in accordance with an embodiment of the present disclosure.

FIG. 14 illustrates an example block diagram (1400) for improving the path loss model performance, in accordance with an embodiment of the present disclosure.

FIG. 15 illustrates an example diagram (1500) for RSRP prediction based on grid cells and antenna parameters, in accordance with an embodiment of the present disclosure.

FIG. 16 illustrates an example block diagram generating RSRP estimation (1600) for the 5G network based on the fourth generation (4G) ANN model, in accordance with an embodiment of the present disclosure.

FIG. 17 illustrates an example representation (1700) of a Random Forest Technique designed for the 5G error correction model, in accordance with an embodiment of the present disclosure.

FIGS. 18A-18C illustrate example graphs (1800A, 1800B, 1800C) representing a loss curve, in accordance with embodiments of the present disclosure.

FIG. 19 illustrates an example graph (1900) representing a comparison of a predicted RSRP and an actual RSRP based on a distance for an arbitrary cell, in accordance with embodiments of the present disclosure.

FIG. 20 illustrates an example graph (2000) representing the RSRP prediction distribution for each demographical category/grid, in accordance with embodiments of the present disclosure.

FIG. 21A-21B illustrate example representations (2100A, 2100B) of RSRP error distribution for the grids, in accordance embodiments of the present disclosure.

FIGS. 22A-22C illustrate example representations (2200A, 2200B, 2200C) of 5G prediction results for Hyderabad, in accordance with embodiments of the present disclosure.

FIGS. 23A-23C illustrate example representations (2300A, 2300B, 2300C) of 5G prediction results for Chennai as an example, in accordance with embodiments of the present disclosure.

FIGS. 24A-24C illustrate example representations (2400A, 2400B, 2400C) of 5G prediction results for Ahmedabad as an example, in accordance with embodiments of the present disclosure.

FIG. 25 illustrates an example computer system (2500) in which or with which embodiments of the present disclosure may be implemented.

The foregoing shall be more apparent from the following more detailed description of the disclosure.

### DEATILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

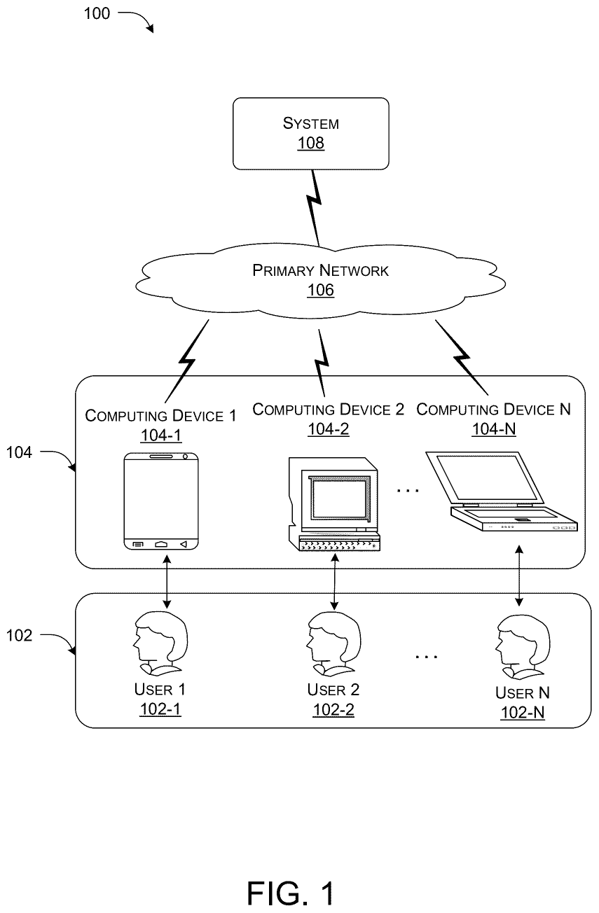

The various embodiments throughout the disclosure will be explained in more detail with reference to FIGS. 1-25.

FIG. 1 illustrates an example network architecture (100) for implementing a proposed system (108), in accordance with an embodiment of the present disclosure.

As illustrated in FIG. 1, the network architecture (100) may include a system (108). The system (108) may be connected to one or more computing devices (104-1, 104-2 . . . 104-N) via a primary network (106). The one or more computing devices (104-1, 104-2 . . . 104-N) may be interchangeably specified as a user equipment (UE) (104) and be operated by one or more users (102-1, 102-2 . . . 102-N). Further, the one or more users (102-1, 102-2 . . . 102-N) may be interchangeably referred as a user (102) or users (102).

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from the user (102) such as a touch pad, touch-enabled screen, electronic pen, and the like may be used. A person of ordinary skill in the art will appreciate that the computing devices (104) may not be restricted to the mentioned devices and various other devices may be used.

In an embodiment, the primary network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The primary network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive one or more data parameters associated with the primary network (106). The one or more data parameters may be based on a network configuration of the primary network (106). The one or more data parameters received by the processor (202) may include but not limited to a frequency, one or more physical parameters, and an antenna pattern associated with the primary network (106).

In an embodiment, the system (108) may predict via a trained learning model a reference signal received power (RSRP) associated with the primary network (106) based on the one or more data parameters. The system (108) may use a Naïve RSRP prediction technique to predict the RSRP via the trained learning model. The trained learning model may be based on a trained secondary network model.

In an embodiment, the trained secondary network model used by the system (108) may be configured to receive one or more secondary data parameters associated with a secondary network. The one or more secondary data parameters may be based on a network configuration for the secondary network. The trained secondary network model may be configured to predict via a secondary learning model a reference signal received power (RSRP) associated with the secondary network based on the one or more secondary data parameters. The trained secondary network model may be configured to receive one or more secondary user parameters. The one or more secondary user parameters may be based on an actual RSRP received from a computing device (104) connected to the secondary network.

In an embodiment, the trained secondary network model may be configured to determine an average RSRP based on the received one or more secondary user parameters and one or more predetermined geographical frameworks associated with a computing device (104) connected to the secondary network. The one or more predetermined geographical frameworks may include but not limited to a geographical area associated with the computing device (104) and a topography mapping associated with said at least geographical area.

In an embodiment, the trained secondary network model may be configured to identify one or more computing devices among the one or more predetermined geographical frameworks connected to the secondary network. The trained secondary network model may be configured to generate a total average RSRP based on the average RSRP and a RSRP associated with the identified one or more computing devices. The trained secondary network model may be configured to generate via a machine learning technique, a secondary error correction model based on the total average RSRP and the predicted RSRP. The machine learning technique may be an Artificial Neural Network (ANN) technique.

In an embodiment, the machine learning technique may incorporate supervised learning, where a machine learning model defines the relationship between input data and target based on training data. The machine learning model may predict an output variable for test data based on these relationships. As the scenario varies dynamically with the user density, clutter and terrain variation, buildings, and other environmental factors, the machine learning model may build the relationship between these input and output variables in all the scenarios.

In an embodiment, the trained secondary network model may be configured to receive the one or more secondary user parameters and generate an activation function to compute a measured RSRP based on the one or more secondary user parameters and the total average RSRP. Further, trained secondary network model may be configured to compute the activation function using an average regularized gradient such that a difference between the predicted RSRP and the measured RSRP is zero.

In an embodiment, the system (108) may receive one or more user parameters. The one or more user parameters may be based on an actual RSRP received from a computing device (104) connected to the primary network (106). The one or more user parameters received by the system (108) may include but not limited to a label switch router (LSR) data, a Latitude data, a Longitude data, one or more radio frequency parameters, and a device configuration data.

In an embodiment, the system (108) may generate an error estimation via an error correction model based on the predicted RSRP and the actual RSRP. The system (108) may use a Random Forest technique to generate the error estimation via the error correction model. Further, the system (108) may determine an estimated RSRP associated with the primary network (106) based on the error estimation. The system (108) may generate an optimized model via the error correction model. The optimized model may be based on a variance between the predicted RSRP and the actual RSRP.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

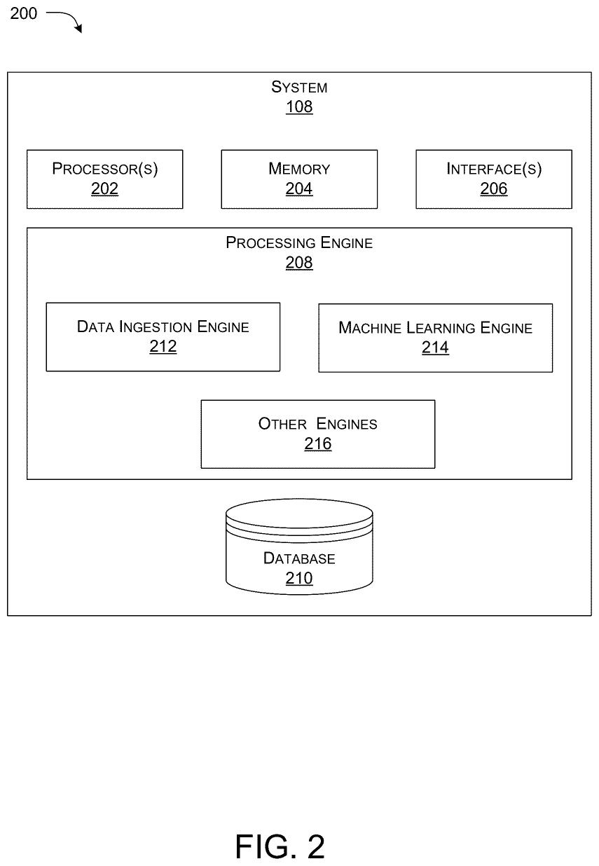

FIG. 2 illustrates an example block diagram (200) of a proposed system (108), in accordance with an embodiment of the present disclosure.

Referring to FIG. 2, the system (108) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (108). Examples of such components include, but are not limited to, processing engine(s) (208) and a database (210), where the processing engine(s) (208) may include, but not be limited to, a data ingestion engine (212), a machine learning engine (214), and other engine(s) (216). In an embodiment, the other engine(s) (216) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the processor (202) may receive one or more data parameters via the data ingestion engine (212). The one or more data parameters may be associated with the primary network (106). The processor (202) may store the one or more data parameters in the database (210). The one or more data parameters may be based on a network configuration of the primary network (106). The one or more data parameters received by the processor (202) may include but not limited to a frequency, one or more physical parameters, and an antenna pattern associated with the primary network (106).

In an embodiment, the processor (202) may predict via a trained learning model a RSRP associated with the primary network (106) based on the one or more data parameters. The processor (202) may use a Naïve RSRP prediction technique to predict the RSRP via the trained learning model. The trained learning model may be based on a trained secondary network model.

In an embodiment, the trained secondary network model used by the processor (202) may be configured to receive one or more secondary data parameters associated with a secondary network. The one or more secondary data parameters may be based on a network configuration for the secondary network. The trained secondary network model may be configured to predict via a secondary learning model a RSRP associated with the secondary network based on the one or more secondary data parameters. The trained secondary network model may be configured to receive one or more secondary user parameters. The one or more secondary user parameters may be based on an actual RSRP received from a computing device (104) connected to the secondary network.

In an embodiment, the trained secondary network model used by the processor (202) may be configured to determine an average RSRP based on the received one or more secondary user parameters and one or more predetermined geographical frameworks associated with a computing device (104) connected to the secondary network. The one or more predetermined geographical frameworks may include but not limited to a geographical area associated with the another computing device (104) and a topography mapping associated with said at least geographical area.

In an embodiment, the trained secondary network model used by the processor (202) may be configured to identify one or more computing devices among the one or more predetermined geographical frameworks connected to the secondary network. The trained secondary network model used by the processor (202) may be configured to generate a total average RSRP based on the average RSRP and the one or more computing devices. The trained secondary network model used by the processor (202) may be configured to generate a secondary error correction model via a machine learning technique based on the total average RSRP and the predicted RSRP. The machine learning technique may be an ANN technique generated by the machine learning engine (214).

In an embodiment, the trained secondary network model used by the processor (202) may be configured to receive the one or more secondary user parameters and generate an activation function to compute a measured RSRP based on the one or more secondary user parameters and the total average RSRP. Further, trained secondary network model used by the processor (202) may be configured compute the activation function using an average regularized gradient such that a difference between the predicted RSRP and the measured RSRP is zero.

In an embodiment, the processor (202) may receive one or more user parameters. The one or more user parameters may be based on an actual RSRP received from a computing device (104) connected to the primary network (106). The one or more user parameters received by the processor (202) may include but not limited to a label switch router (LSR) data, a Latitude data, a Longitude data, one or more radio frequency parameters, and a device configuration data.

In an embodiment, the processor (202) may generate an error estimation via an error correction model based on the predicted RSRP and the actual RSRP. The processor (202) may use a Random Forest technique to generate the error estimation via the error correction model. Further, the processor (202) may determine an estimated RSRP associated with the primary network (106) based on the error estimation. The processor (202) may generate an optimized model via the error correction model. The optimized model may be based on a variance between the predicted RSRP and the actual RSRP.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

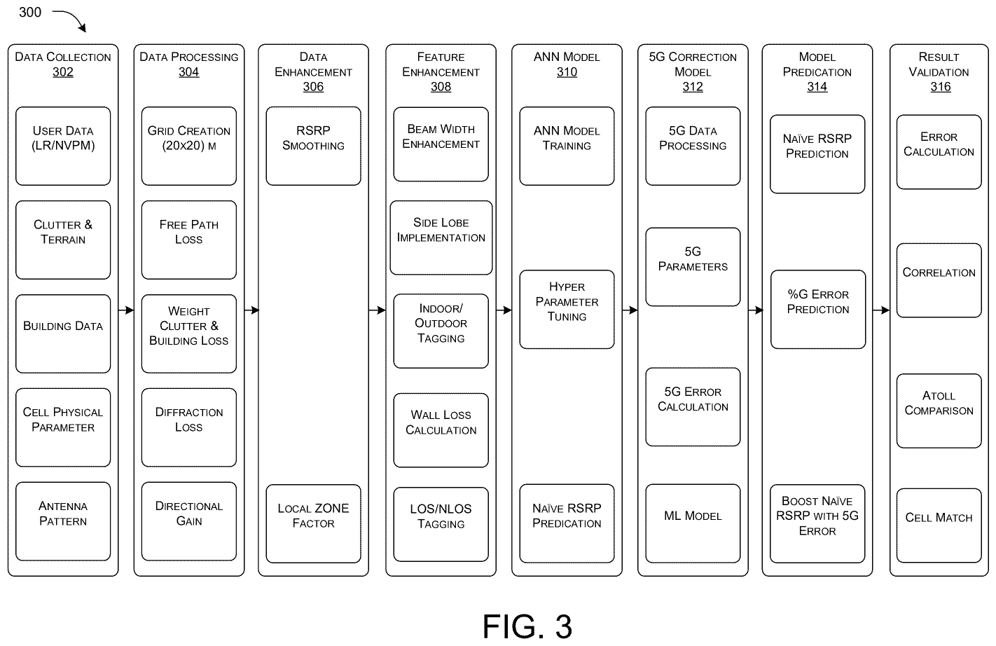

FIG. 3 illustrates an example closed loop workflow (300) for a pathloss prediction model, in accordance with an embodiment of the present disclosure.

As illustrated in FIG. 3, in an embodiment, the closed loop workflow (300) may include a data collection module (302). The data collection module (300) may include data but not limited to a user data, a clutter and terrain data, a building data, one or more cell physical parameters, and an antenna pattern.

In an embodiment, output from the data collection module (302) may be provided to a data processing module (304). The data processing module (304) may include but not limited to a grid creation, a free path loss, a weighted clutter and building loss, a diffraction loss, and a directional gain.

In an embodiment, output from the data processing module (304) may be provided to a data enhancement module (306). The data enhancement module (306) may include but not limited to a RSRP smoothing and a local zone factor.

In an embodiment, output from the data enhancement module (306) may be provided to a feature enrichment module (308). The feature enrichment module (308) may include but not limited to a beam bandwidth enhancement, a side lobe implementation, an indoor/outdoor tagging, a wall loss calculation, and a visual line of sight (LOS)/no visual line of sight (NLOS) tagging.

In an embodiment, output from the feature enrichment module (308) may be provided to an ANN model module (310). The ANN model module (310) may include but not limited to an ANN model training, a Hyper parameter tuning, and a Naïve RSRP prediction.

In an embodiment, output from the ANN model module (310) may be provided to a fifth generation (5G) error correction module (312). The 5G error correction module (312) may include but not limited to a 5G data processing, one or more 5G parameters, a 5G error calculation, and a machine learning (ML) model.

In an embodiment, output from the 5G error correction module (312) may be provided to a model prediction module (314). The model prediction module (314) may include but not limited to the Naïve RSRP prediction, the 5G error prediction, and a Boost Naïve RSRP with 5G error.

In an embodiment, output from the model prediction module (314) may be provided to a result validation module (316). The result validation module (316) may include but not limited to an error calculation, a correlation, an Atoll comparison, and a cell match.

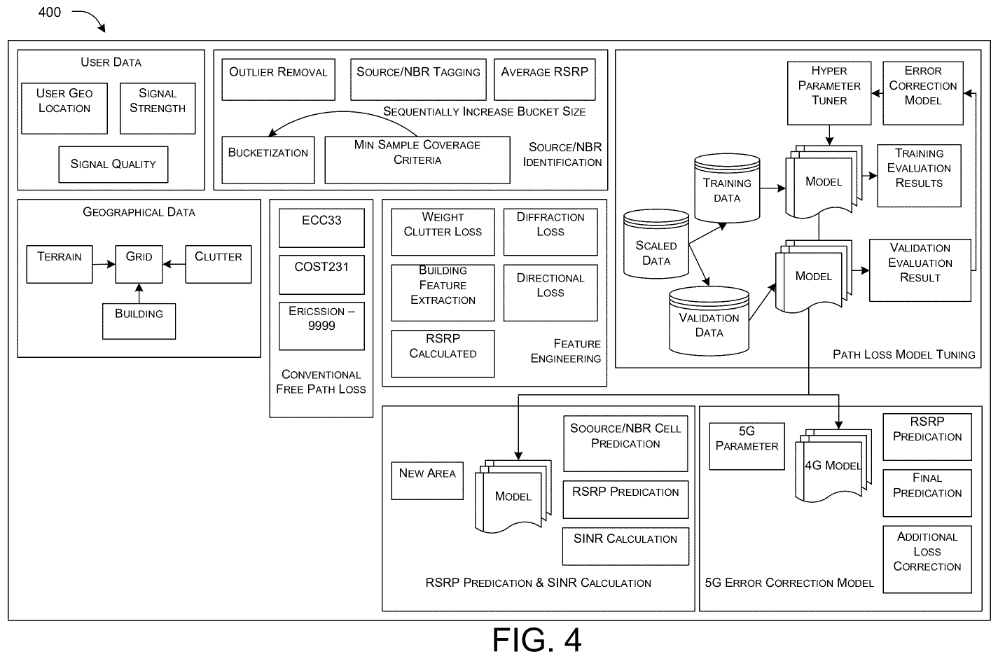

FIG. 4 illustrates an example architecture (400) of the closed loop workflow, in accordance with an embodiment of the present disclosure.

As illustrated in FIG. 4, the example architecture (400) may include the following features.

In an embodiment, a geographical area may be partitioned into multiple grids where each grid may be a square region with a size parameter. Further, geographical area may be mapped with topography information that may include but not limited to terrain, clutter, and building to find clutter loss, terrain elevation, building height, building coverage area.

In an embodiment, if more than one building is falling on the same grid of the multiple grids, a largest building area may be considered. In addition, a number of buildings falling, building height may also be captured as a part of data collection.

In an embodiment, user data of one week may be collected that may include but not limited to label switch router (LSR)/NVPM. One or more samples may be extracted from the user data that may include but not limited to geographical properties such as Latitude, Longitude, and environment. Further, network radio frequency (RF) parameters that may include but not limited to RSRP, signal interference to noise ratio (SINR) may also be recorded. Device information from the computing device (104) may also be recorded.

In an embodiment, the user data maybe filtered out based on a high confidence level to avoid errors based on a location inaccuracy. Further, cell physical parameters from a master data base may also be taken as a part of the data collection.

In an embodiment, the antenna pattern may be investigated to record an antenna gain in a spatial direction. Additionally, coverage boundary of each cell may be created based on a location, a coverage radius, an antenna type, and a demographical category. Further, while creating a coverage layer of each cell, a side lobe may also be taken into account but with half power. Furthermore, samples that do not belong to the coverage layers may be removed for further processing.

In an embodiment, filtered LSR samples may be mapped with the designed grid. Further, source, neighbor cell tagging may be determined with their RSRP. Based on an environment parameter, the LSR data grids may be tagged as indoor and outdoor.

In an embodiment, user height may be considered and an appropriate factor may be added to the user height based on the terrain and building. Further, an antenna height may also be recorded based on the terrain elevation.

In an embodiment, a free path loss of each grid using antenna parameters may be computed. Conventional methods may include but not limited to Cost 231, ECC-3, and Ericsson-9999 models may be used based on the frequency and the distance of the computing devices (104). Further, a weighted clutter loss for each grid may be calculated based on a nearby clutter loss. Additionally, based on a number of obstacles between grid and the cell, a diffraction loss may be calculated.

In an embodiment, while calculating the wall loss effect, a variation in building height may be considered where if the building height is between/more than a source or a receiver height, a α decibel (dB) loss may be considered and an additional β dB for subsequent walls may be considered. Further, a weighted building loss calculation may be calculated based on the indoor/outdoor parameters.

In an embodiment, a directional loss may be calculated based on the antenna pattern data and the grid's horizontal/vertical deviation from a main lobe of the antenna. Hence, a RSRP on each grid may be calculated as follows.

In an embodiment, the system (108) may calculate the weighted clutter loss, a building feature extraction, a diffraction loss, the directional loss and a RSRP.

In an embodiment, the system (108) may compute the RSRP, where the calculated RSRP=Transmission Power+Antenna Gain+Port Gain−Conventional Path Loss−Directional Loss−Clutter Loss−Building Wall Loss.

In an embodiment, the system (108) may provide a path loss model tuning based on a training data, a scaled data, and a validation data. Further, the system (108) may use an error correction model and train the error correction model using a Hyper parameter tuner. Further, the system (108) may generate a path loss model.

In an embodiment, the system (108) may use the path loss model for a new area/geographical location to generate a RSRP prediction associated with the new area. Further, the system (108) may generate source/neighbour (NBR) cell prediction and a SINR calculation associated with the RSRP prediction.

In an embodiment, the system (108) may use the path loss model associated with the primary network (106) to generate the RSRP prediction to generate a final prediction associated with the secondary network incorporating an additional loss correction. In an embodiment, the primary network (106) may include but not limited to a fourth generation (4G) network and the secondary network may include but not limited to a 5G network.

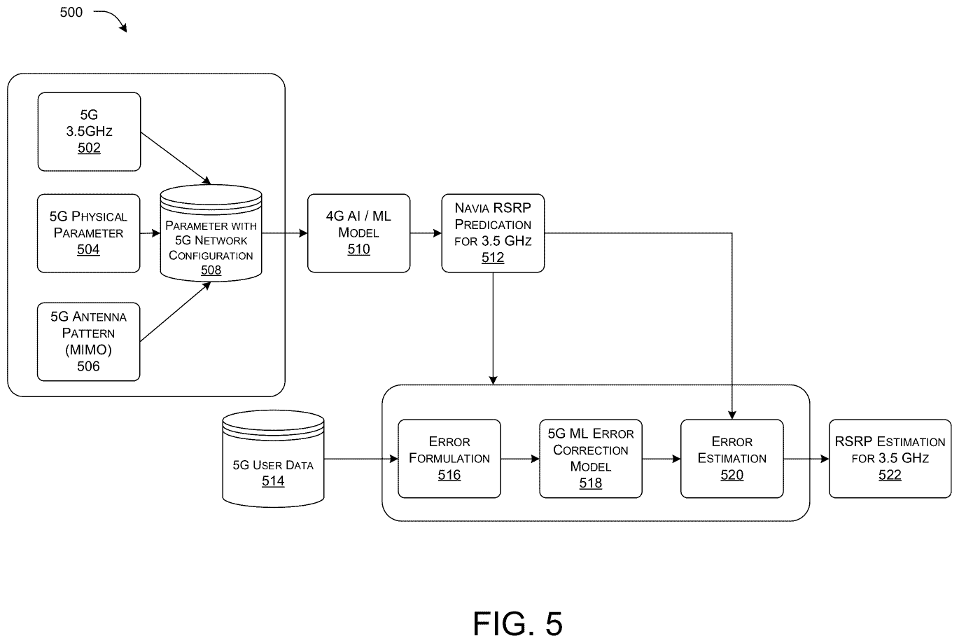

FIG. 5 illustrates an example 5G prediction workflow diagram (500), in accordance with an embodiment of the present disclosure.

As illustrated in FIG. 5, in an embodiment, parameters with 5G network configuration may be received by the system (108). The parameters may include but not limited to a 5G frequency (502), a 5G physical parameter (504), and a 5G Multiple-Input-Multiple Output (MIMO) antenna pattern (506). The system (108) may generate a Naïve RSRP prediction (512) via a 4G artificial intelligence/machine learning (AI/ML) model (510). Further, the system (108) may receive a 5G user data (514) and the predicted Naïve RSRP data to calculate the error formulation (516) associated with the generated RSRP. Further, the system (108) may receive the error formulation output and generate an error estimation (520) associated with the RSRP via the 5G ML error correction model (518). Hence, the system (108) may generate a RSRP estimation (522) associated with the 5G network.

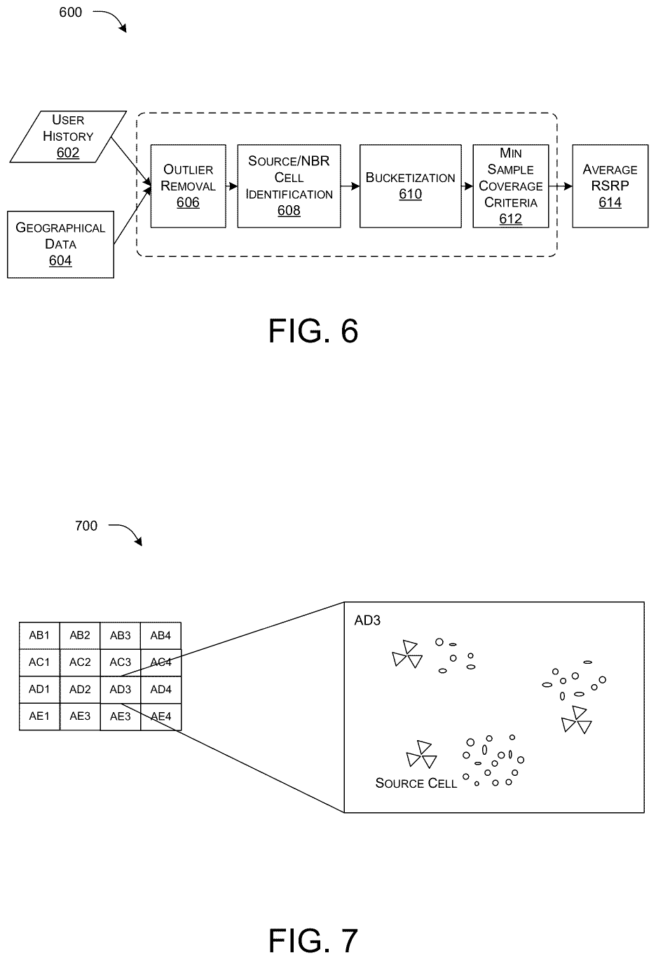

FIG. 6 illustrates an example RSRP estimation (600) based on neighbouring cells within a grid, in accordance with an embodiment of the present disclosure.

As illustrated in FIG. 6, in an embodiment, a user history (602) and a geographical data (604) may be for calculating the average RSRP. Outliers (606) may be removed from the user history (602) and the geographical data (604) to generate a filtered data. Further, a source/NBR cell identification process (608) may be followed on the filtered data. A process of bucketization (610) may be implemented where a sample may be bifurcated into sequential incremental buckets with a size α1 decibel. A minimum sample coverage area (612) may be observed from the buckets to generate the average RSRP (614).

FIG. 7 illustrates an example assignment (700) of cell identifications within the grid, in accordance with an embodiment of the present disclosure.

As illustrated in FIG. 7, in an embodiment, a user history data may be mapped with the designed grid and a RSRP threshold may be configured based on the cell to remove the outliers from each grid. Further, in each grid, a minimum sample Sₘᵢₙ may be expected from each cell and cell samples in the grids may be discarded if they do not fulfil the Sₘᵢₙ requirement. Further, assignment of a cell (ID) as a source cell for each grid has been performed based on a maximum number of samples in that grid.

In an embodiment, to find the neighbors cells, a N1 neighbor reported by the neighbor cells may also be considered for calculations. Further, the neighbor cells may be selected based on a similar primary synchronization signal (PSS). If % of NBR samples >α% the following steps may be implemented.

If Source <min Source Sample and NBR>min NBR Sample and % of N1 samples >β% the next step may be implemented. Now for each Source/NBR cell, a bucketization process may be followed where the input sample may be divided into sequential incremental buckets with the size α1 dB. Further, the total number of samples in each bucket may be calculated and a bucket with highest number of samples may be chosen for processing.

In an embodiment, if samples % in the chosen bucket <β1%, the bucket size may be incremented by 1 dB sequentially till either % samples criteria or β2 dB bucket size is observed. Further, average RSRP of the samples belonging to the selected bucket may be calculated and the RSRP value may be assigned to the grid based on the samples of source/NBR cell.

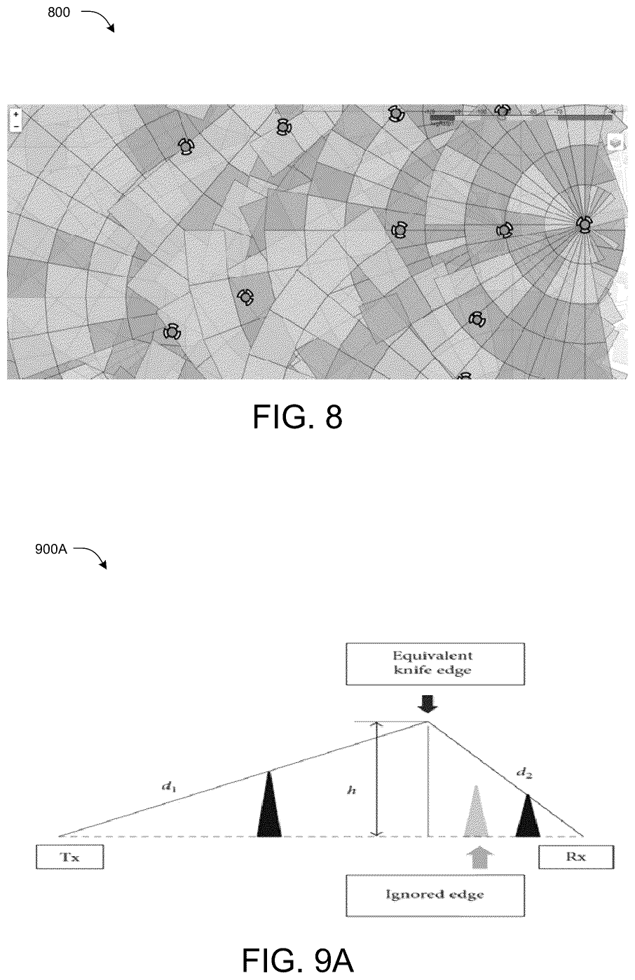

FIG. 8 illustrates an example diagram (800) based on a local zone factor, in accordance with an embodiment of the present disclosure.

As illustrated in FIG. 8, once the average RSRP value is assigned to the grid based on the samples of source/NBR cell, a locally weighted smoothing process may be performed on the RSRP values that have reduced the high variance of nearby grids. Further, a local zone factor may be introduced further to suppress the RSRP values which may not be required. Hence, to obtain only the required RSRP values, a zone wise RSRP value may be obtained by dividing the coverage area of each cell by several zones of azimuth and distance. Further, the grid with zone may be mapped and if the RSRP of grid is more or less a2 dB than a coverage area, the RSRP of the grid may be replaced with the zone wise RSRP.

In an embodiment, various conventional models may be used for free path loss calculation. A Cost 231 model may be implemented where the path loss of the Cost 231 model may be defined as follows:

$$P L = 46.3 + 33 \text{.9} log 10 ( f ) - 13.82 log 10 ( hb ) - ahm + ( 44.9 - 6.55 log 10 ( hb ) ) log 10 d + cm$$

The parameter “ahm” is defined for urban environment as:

$$ahm = 3.20 ( log 10 ( 11.75 hr ) ) 2 - 4.97$$

For suburban or rural (flat) environment:

$$ahm = ( 1.1 log 10 f - 0.7 ) hr - ( 1.56 log 20 f - 0.8$$

In an embodiment, an ECC-33 model for path loss may be implemented where the path loss of the ECC-33 model may be defined as follows:

$$P L = Afs + A b m - G b - Gr \\ Afs = 92.4 + 20 log 10 ( d ) + 20 log 10 ( f ) \\ Abm = 20.41 + 9.83 log 10 ( d ) + 7.894 log 10 ( f ) + 9.56 [ log 10 ( f ) ] \hat{} 2 \\ Gb = log 10 ( hb / 200 ) \{ 13. 958 + 5.8 [ log 10 ( d ) ] \hat{} 2 \} \\ Gr = [ 42.57 + 137 log 10 ( f ) [ log 10 ( hr ) - 0.585 ]$$

In an embodiment, an Ericsson-9999 model for path loss may be implemented where the path loss of the Ericsson-9999 model may be defined as follows:

$$P L = a 0 + a 1 log 10 ( d ) + a 2 log 10 ( hb ) + a 3 log 10 ( hb ) log 10 ( d ) - 3 \text{.2} ( log 10 ( 11.75 hr ) \hat{} 2 ) + g ( f ) \\ g ( f ) = 44 \text{.49} log 10 ( f ) - 4.78 ( log 10 ( f ) )$$

In an embodiment, a weighted clutter loss calculation may be used to account for additional weightage from the nearby clutter. The losses due to clutter may be estimated over a maximum distance from the receiver.

In an embodiment, a weighing function may be used to calculate the weight of the clutter loss on each grid and from the grid in the direction of transmitter, up to a defined maximum distance.

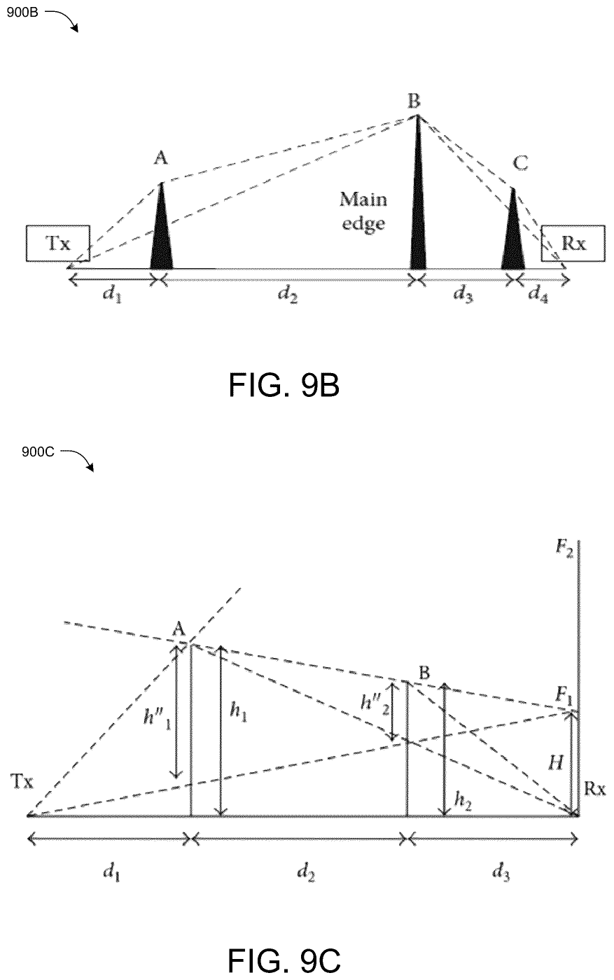

FIGS. 9A-9C illustrate example methods (900A, 900B, 900C) for calculating a diffraction loss within the grid, in accordance with embodiments of the present disclosure.

As illustrated in FIGS. 9A-9C, a top N_{b} of a building and/or terrain in line of sight between a transmitter and a receiver may be considered.

As illustrated in FIG. 9A, in an embodiment, a Bullington method may be used where the real terrain may be reduced to a single equivalent knife edge. The location of the equivalent knife edge is the point at which the extended lines join the transmitter and receiver and their respective dominant obstacles meet. The diffraction loss may be calculated using the following equation.

$$J ( v ) = 6.9 + 20 log ( \sqrt{{( v - 0.1 )}^{2} + 1} + v - 0.1 ) ( db ) . \\ v = h \sqrt{\frac{2}{λ} ( \frac{1}{{d}_{1}} + \frac{1}{{d}_{2}} )} ,$$

As illustrated in FIG. 9B, in an embodiment, a Deygout method may be used where first step may include computing a ‘v’ parameter for each edge alone, as if all other edges were absent. If edge B is the main edge, then the diffraction losses, which are J(vD_A) and J(vD_C), for edge A and edge C may be found with respect to a line joining the main edge to a Tx and a Rx. The Tx and the Rx may be added to the main edge loss (J(vD_B)) to obtain a total approximated diffraction loss (LD). This process may be repeated until all the edges have been considered for more than three edges.

As illustrated in FIG. 9B, in an embodiment, a Causebrook method may be used where a correction factor may be used to reduce an overestimation problem associated with Deygout method.

$$Lcorrected = L - C 1 - C 2 \\ Where L : diffraction loss from the Deygout method$$

$$C 1 = ( 6 - L 2 + L 1 ) cos α1 , C 2 = ( 6 - L 2 + l 3 ) cos α2 \\ cos α1 = \sqrt{d 1 ( d 3 + d 4 ) / ( d 1 + d 2 ) ( d 2 + d 3 + d 4 )} \\ cos α2 = \sqrt{( d 1 + d 2 ) d 4 / ( d 1 + d 2 + d 3 ) ( d 3 + d 4 )}$$

As illustrated in FIG. 9C, in an embodiment, a Giovanelli method may be used when two obstacles are present between a transmitter and a receiver. This method may be further elaborated by the equation below.

$${L}_{G V} = J ( v ( d 1 , d 2 + d 3 , {h}_{1}^{″} ) ) + J ( v ( d 2 , d 3 , {h}_{2}^{″} ) )$$

In an embodiment, a building weighted indoor factor may be incorporated based on an identification of the grid. The grid may be classified as indoor or outdoor. However, to know how deep the grid is within building a weighted value of grids surrounding a base grid may be calculated. The weighted indoor parameter may be estimated over a maximum distance from the base grid. Further, a weighing function may be used to calculate the weight of the nearby building structure to a defined maximum distance. The maximum distance may indicate the distance from the base grid for which nearby building structures may be considered via the weighing function where the influence of nearby building structures may diminish with distance.

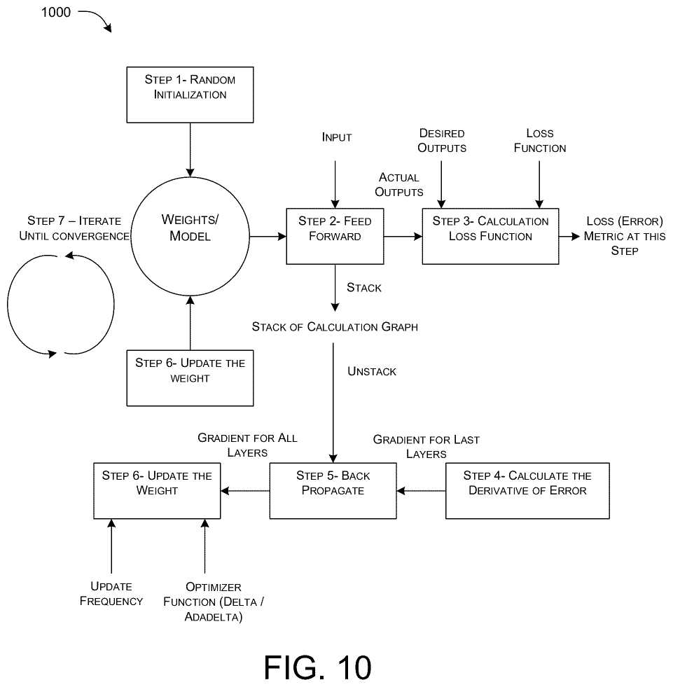

FIG. 10 illustrates an example path loss model training (1000) using an Artificial Neural Network (ANN) technique, in accordance with an embodiment of the present disclosure.

In an embodiment, the ANN technique may be used by the system (108) for generating a path loss model. The ANN technique consist a layer of input nodes and layer of output nodes connected by one or more layers of hidden nodes.

As illustrated in FIG. 10, weights in the path loss model may be updated based on a comparison between inputs and actual outputs. A loss function may be calculated to check for a loss metric and further derivative of the loss metric may be used to back propagate the path loss model and update the weights until a termination of the loss metric or until convergence.

In an embodiment at step 1, the system (108) may provide random initialization of the model. Further at step 2, the system (108) may receive an input and use a feed forward process to generate actual outputs. At step 3, the system (108) may calculate a loss function to generate the loss (error) metric. At step 4, the system (108) may calculate a derivative of the loss (error) metric. At step 5, the system (108) may use a gradient of previous layers, use information from a stack calculation graph associated with the inputs and a use a back propagation process to generate a gradient associated with all the layers. At step 6, the system (108) may update the weights based on an update frequency and an optimizer function (DELTA). At step 7, the system (108) may train the model until convergence.

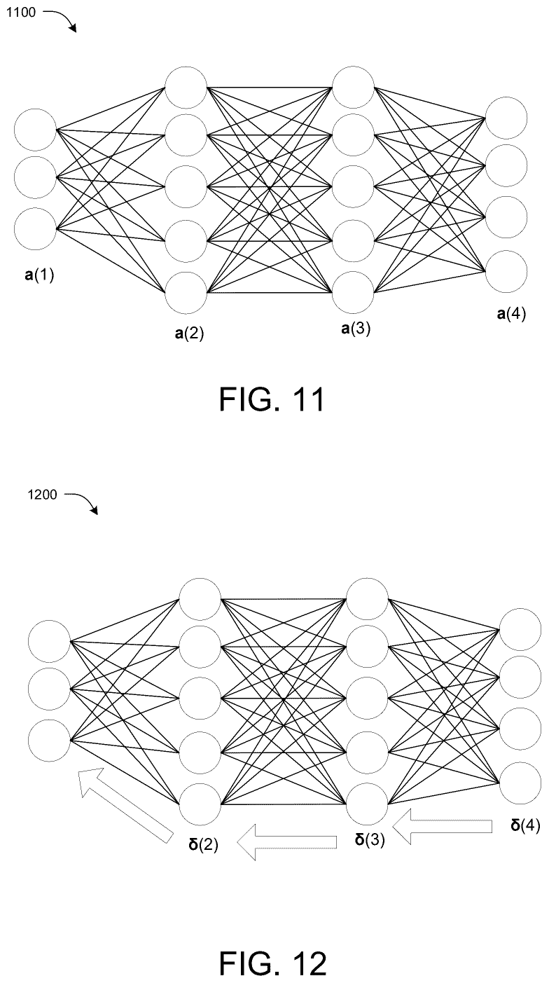

FIG. 11 illustrates an example forward propagation (1100) for the path loss model, in accordance with an embodiment of the present disclosure.

As illustrated in FIG. 11, in an embodiment, a forward propagation method may be used by the system (108) where an input layer nodes may pass information to hidden layer nodes. The hidden layers may apply the weighing functions and as a value of a particular node or set of nodes in the hidden layer reaches a threshold, firing of an activation function may be initiated and a value may be passed to multiple layer nodes in an output layer.

$$Given one labeled training instance ( x , y ) : \\ {a}^{( 1 )} = x \\ {z}^{( 2 )} = {Θ}^{( 1 )} {a}^{( 1 )} \\ {a}^{( 2 )} = g ( {z}^{( 2 )} ) [ add {a}_{0}^{( 2 )} ] \\ {z}^{( 3 )} = {Θ}^{( 2 )} {a}^{( 2 )} \\ {a}^{( 3 )} = g ( {z}^{( 3 )} ) [ add {a}_{0}^{( 3 )} ] \\ {z}^{( 4 )} = {Θ}^{( 3 )} {a}^{( 3 )} \\ {a}^{( 4 )} = {h}_{Θ} ( x ) = g ( {z}^{( 4 )} )$$

Further, in an embodiment, a cost function may be calculated may be calculated based on the following equation.

$$J ( Θ ) = - \frac{1}{n} [ {\sum }_{i = 1}^{n} {\sum }_{k = 1}^{K} {y}_{ik} log {( {h}_{Θ} ( {x}_{i} ) )}_{k} + ( 1 - {y}_{ik} ) log ( 1 - {( {h}_{Θ} ( {x}_{i} ) )}_{k} ) ] + \frac{λ}{2 n} {\sum }_{l = 1}^{L - 1} {\sum }_{i = 1}^{{s}_{i - 1}} {\sum }_{j = 1}^{{s}_{j}} {( {Θ}_{ji}^{( l )} )}^{2}$$

FIG. 12 illustrates an example backward propagation (1200) for the path loss model, in accordance with an embodiment of the present disclosure.

As illustrated in FIG. 12, in an embodiment, a backward propagation method may be used by the system (108) where each hidden node j may be responsible for some fraction of the error 8; (1) in each of the output nodes to which it connects. 8; (1) may be divided according to the strength of a connection between a hidden node and an output node. Then, a “blame” may be propagated back to provide the error values for the hidden layer.

Further, in an embodiment, the backward propagation method used by the system (108) may include multiple steps where the weights may be updated by the calculated gradient. The backward propagation method may be used until a value of the weights assist in achieving convergence.

| | |
|---|---|
| δᵢⱼ^{(ι)} | Let = “error” of node j in layer ι |

(#layers [symbol] = 4)
Backpropagation

| | |
|---|---|
| • δ⁽⁴⁾ = a⁽⁴⁾ − y • δ⁽³⁾ = (Θ⁽³⁾)^{T} δ⁽⁴⁾. • δ⁽²⁾ = (Θ⁽²⁾)^{T} δ⁽³⁾. • (No δ⁽¹⁾) | 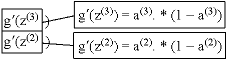 |
| $\frac{\partial }{\partial Θ ij ( ι )} J ( Θ ) = {{a}_{j}}^{( ι )} {{δ}_{i}}^{( ι + 1 )}$ | (ignoring λ; if λ = 0) |

Given: training set {(x₁, y₁), . . . , (Xₙ, yₙ)}
Initialize all (Θ^{(ι)}) randomly (NOT to 0!)
Loop // each iteration is called an epoch

| | |
|---|---|
| Set Δᵢⱼ^{(ι)} = ∀1, i, j | (Used to accumulate gradient) |

```
  For each training instance (xᵢ, yⱼ):
    Set a⁽¹⁾ = xᵢ
    Compute {a⁽²⁾, . . . , a^{(L)}} via forward propagation
    Compute δ^{(L)} = a^{(L)} − yᵢ
    Compute errors {(δ^{L-1}, . . . , δ⁽²⁾}
    Compute gradients Δᵢⱼ^{(ι)} = Δᵢⱼ^{(ι)} + aⱼ⁽¹⁾ δᵢ^{(ι+1)}
$Compute avg regularized gradient {{D}_{ij}}^{( ι )} = \{ \begin{matrix}\frac{1}{n} {{Δ}_{ij}}^{( ι )} + {{λΘ}_{ij}}^{( ι )} & if j \neq 0 \\ \frac{\partial y}{\partial x} {{Δ}_{ij}}^{( ι )} & otherwise\end{matrix}$
```

Update weights via gradient step Θᵢⱼ^{(ι)}=Θᵢⱼ^{(ι)}−αDᵢⱼ^{(ι)}
Until weights converge or max #epochs are reached.

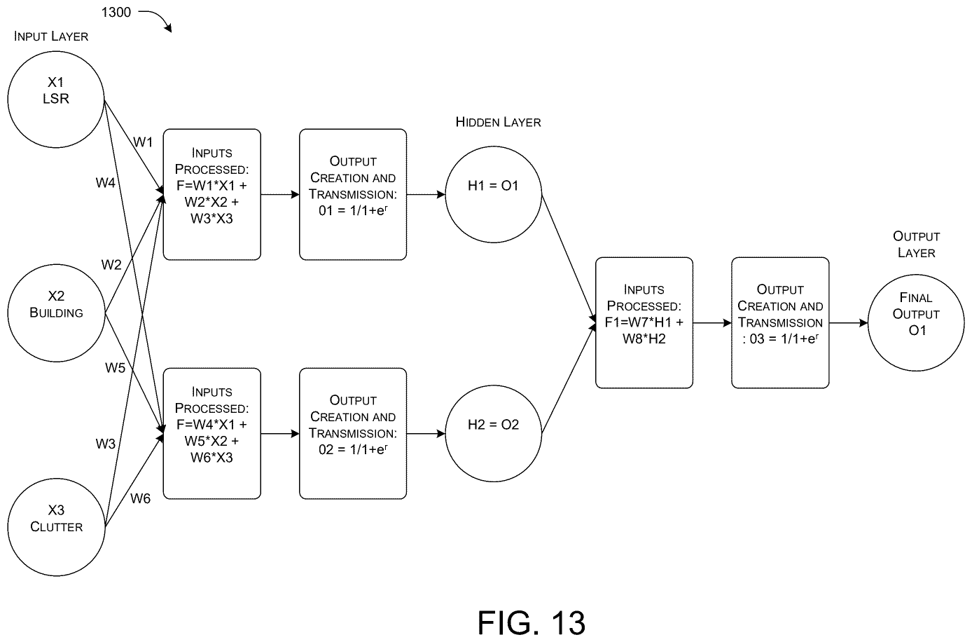

FIG. 13 illustrates an example training (1300) of the designed ANN model, in accordance with an embodiment of the present disclosure.

As illustrated in FIG. 13, in an embodiment the ANN model may receive inputs via an input layer that may include but not limited to a label switch router (LSR), a building data, and a clutter data. The system (108) may process the inputs and generate an output creation for transmission. An activation function may be used to generate the output creation. Further, the ANN model may include α3 hidden layers with several nodes in each layer where regularization and an early stopping criterion may be added to avoid overfitting.

In an embodiment, the ANN model may be evaluated using a holdout evaluation method test the model on different data. This may provide an unbiased estimate of a learning performance associated with the trained model. In this method, the dataset is may be divided into three subsets.

In an embodiment, a training set may be used where data of m cells may be selected to build predictive models for each band/demographic category. Further, a validation set may be used where 20 percent subset of the training set may be used to assess the performance of the model built in the training phase. The validation set may provide a test platform for fine-tuning a model's parameters and selecting the best performing model. Further, a test may be used to train the model where another set of data (unseen data, different than training set) may be used to assess the future performance of the trained model. Once the trained model is tuned, input test data may be provided to the trained model and the trained model may be evaluated for its performance using metrics mentioned below.
Mean Absolute Error:

$$MAE = \frac{1}{n} {\sum }_{j = 1}^{n} \vert {y}_{j} < {\hat{y}}_{j} \vert$$

Root mean square error:

$$RMSE = \sqrt{{\sum }_{i = 1}^{n} \frac{{( {ý}_{i} < {y}_{i} )}^{2}}{n}}$$

Standard Deviation of error:

$$σ = \sqrt{\frac{\sum {( {x}_{i} < μ )}^{2}}{n}}$$

Correlation:

$$Corr ( x , y ) = \frac{{\sum }_{i = 1}^{n} ( {x}_{i} - {x}^{′} ) ( {y}_{i} - {y}^{′} )}{\sqrt{{\sum }_{i = 1}^{n} {( {x}_{i} - {x}^{′} )}^{2} {\sum }_{i = 1}^{n} {( {y}_{i} - {y}^{′} )}^{2}}}$$

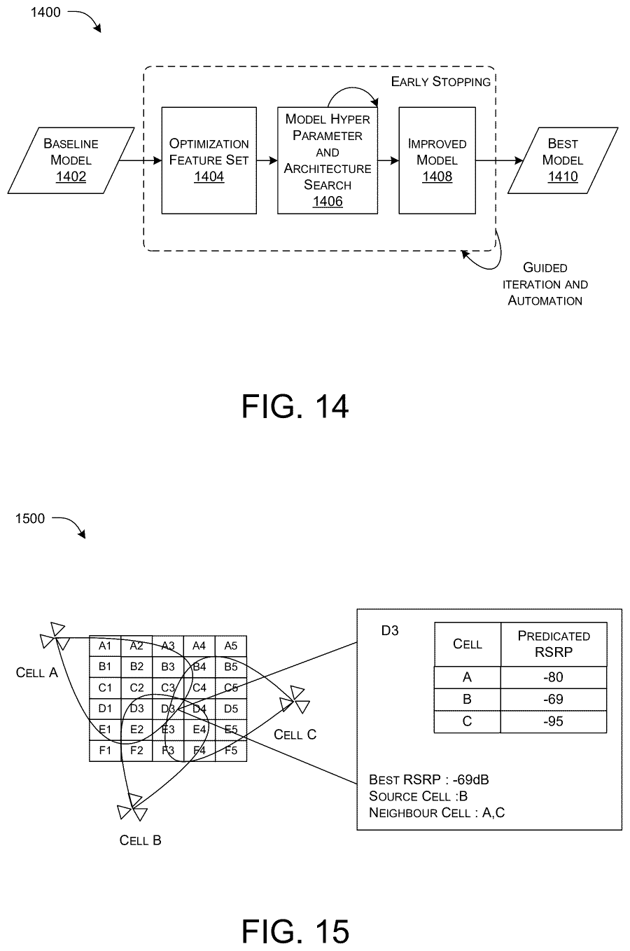

FIG. 14 illustrates an example block diagram (1400) for improving the path loss model performance, in accordance with an embodiment of the present disclosure.

As illustrated in FIG. 14, a baseline model (1402) may be processed to generate an optimized feature set (1404). Further, the optimized feature set (1404) may be further processed using a model hyper parameter and an architecture search (1406) to generate an improved model (1408).

In an embodiment, hyper parameters may include but not limited to a learning rate a, a number of nodes, a number of hidden layers, an epoch size, a batch size, an activation function, and a number of optimizers. Further a dropout rate and an early stopping criterion may be used to avoid overfitting.

FIG. 15 illustrates an example diagram (1500) for RSRP prediction based on grid cells and antenna parameters, in accordance with an embodiment of the present disclosure.

As illustrated in FIG. 15, in an embodiment, once the ANN model is fully trained the same model may be used to predict the RSRP for new area and consequently a SINR may be calculated using the predicted RSRP. A geographical area may be partitioned into multiple grids where each grid may be a square region with a size parameter. The geographical area may be mapped with topography information to determine a clutter loss, a terrain elevation, a building height, and a building coverage area. If more than one building is falling on the same grid, the largest building area may be considered. In addition, a building count may be considered as additional feature. Further, to use the building feature more effectively, a weighted building loss calculation may be performed which may incorporate indoor and outdoor scenarios. A user height (here grid) may be estimated as an “h” meter and an appropriate factor may be added to the user height based on the terrain and the building.

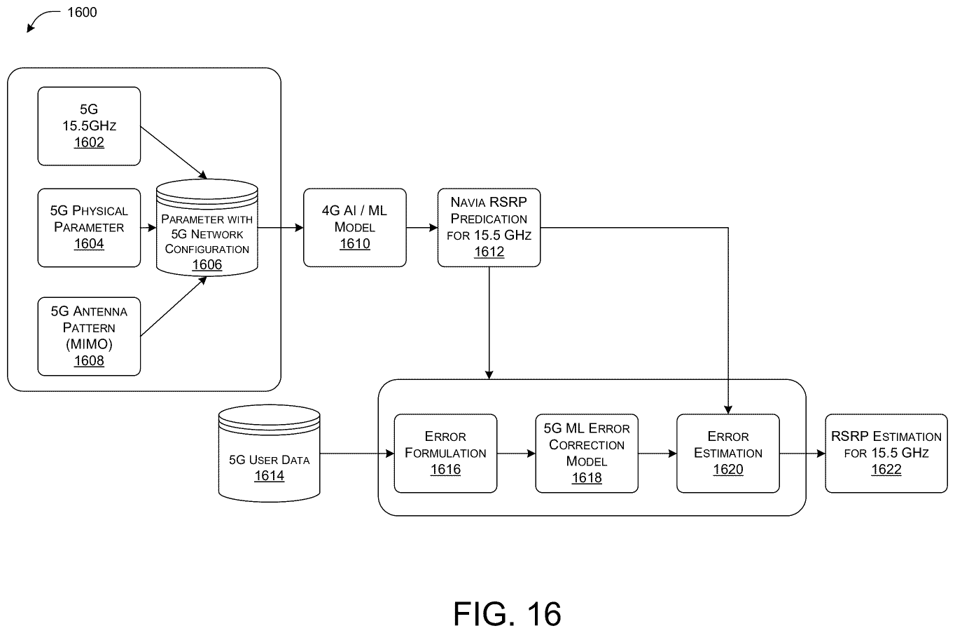

FIG. 16 illustrates an example block diagram generating RSRP estimation (1600) for the 5G network based on the fourth generation (4G) ANN model, in accordance with an embodiment of the present disclosure.

As illustrated in FIG. 16, in an embodiment, for prediction of RSRP cells belonging to the same area and the same band may be considered from a cell master database with antenna parameters. Further, an antenna height may also be updated based on the terrain elevation. Additionally, a coverage boundary of each cell may be created based on its location, coverage radius, antenna type and demographical category. For a multiband antenna beam width may be considered based on an actual sample pattern analysis. For creating a coverage layer of each cell, a side lobe may also be taken into consideration. Once the coverage layer is created, a free path loss associated with each grid and a cell combination based on coverage boundary may be calculated.

In an embodiment, a weighted clutter loss, a diffraction loss and a building wall loss may also be calculated. Further, a directional gain may be calculated based on an antenna pattern data.

In an embodiment, the RSRP for each grid may be calculated and provided to a trained model based on its band and demographical category. Further, for each grid, the predicted RSRP value of a source and a neighbor cell may be reported by the user data. If neighbor cell information is not available then a maximum of nb neighbors cells may be used based on a nearest neighbor logic. Further, the SINR may be calculated as follows. If a neighbor cell is not found, −130 dB RSRP value may be considered for calculating the SINR.

SINR=10 log 10(Source RSRP/(sum(NBR RSRP)+Noise Power))

Noise power=−174+10 log 10(frequency)+7dB(UE noise figure)

As illustrated in FIG. 16, in an embodiment, a 4G ML model (1610) for a given area may be used to calculate the 5G RSRP and the SINR based on a frequency (1602), a physical parameter (1604), and a 5G antenna pattern (1608). The frequency (1602), the physical parameter (1604), and the 5G antenna pattern (1608) may combined with a network configuration (1606) and provided to the 4G ML model (1610) for generating a 5G Naïve RSRP prediction (1612). An user data (1614) may be received by the system (108), where the system (108) may use an error formulation (1616) process to generate a 5G ML error correction model (1618) based on the 5G Naïve RSRP prediction (1612). Further, the system (108) may generate the RSRP estimation (1622) based on an error estimation (1620) associated with the 5G ML error correction model (1618).

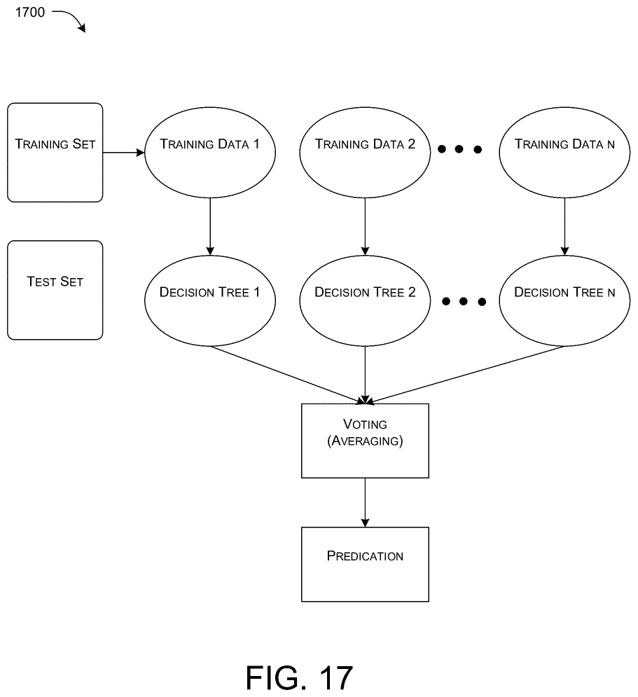

FIG. 17 illustrates an example representation (1700) of a Random Forest Technique designed for the 5G error correction model, in accordance with an embodiment of the present disclosure.

As illustrated in FIG. 17, in an embodiment, the system (108) may receive the 5G user data and calculate the actual 5G RSRP for each grid. Further, the system (108) may calculate the variance between the actual 5G RSRP and the predicted 5G RSRP based on the trained 4G ANN model data for the respective grids. The system (108) may generate an error correction model using the 5G configuration data as input and the variance as a required output.

In an embodiment, the system (108) may use a Random Forest technique where the technique may be a Meta estimator that fits a number of decision trees on various sub samples of datasets and uses averaging to improve the predictive accuracy and control the overfitting.

In an embodiment, the following Pseudocode may be used for generating the RSRP estimation.

For b=1 to B:

A bootstrap sample Z! of size N may be drawn from the training data.

A random-forest tree Tb may be generated with the bootstrapped data, by recursively repeating the following steps for each terminal node of the tree, until the minimum node size “nmin” is reached.

“m” variables may be selected at random from the p variables.

The best variable/split-point among the m variables may be used for calculations.

$$E = - {\sum }_{i = 1}^{N} {p}_{i} {log}_{2} {p}_{i}$$

Information Gain: Information gain may be a measure of how much information a feature provides about a target. Information gain may help to determine the order of attributes in the nodes of a decision tree.

$$Gain ( S , A ) ≡ Entropy ( S ) - {\sum }_{v ∈ {D}_{A}} \frac{\vert {S}_{v} \vert}{\vert S \vert} Entropy ( {S}_{v} )$$

The nodes may be split into two daughter nodes where an output from an ensemble of trees {Tb}B1 may be used to generate a prediction at a new point x:

$${\hat{f}}_{vt}^{{}_{B}} ( x ) = \frac{1}{B} {\sum }_{b = 1}^{B} {T}_{b} ( x ) .$$

Once the model is optimized and tuned, the model may be used for the 5G RSRP prediction for unknown grids by summing up the variance to the Naïve 5G RSRP prediction to generate the final 5G RSRP estimation.

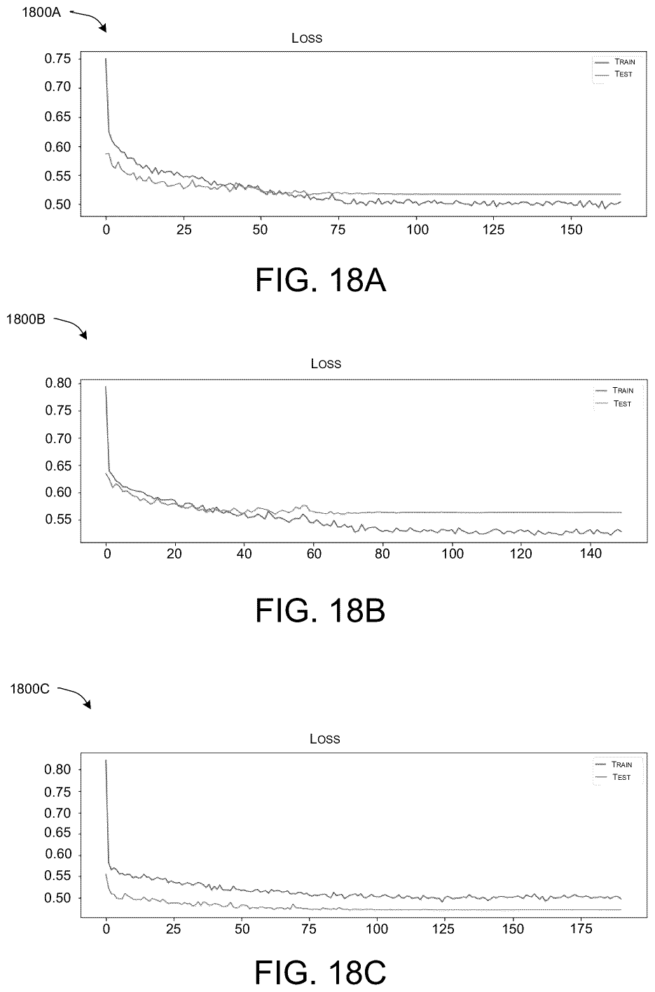

FIGS. 18A-18C illustrate example graphs (1800A, 1800B, 1800C) representing a loss curve, in accordance with embodiments of the present disclosure.

As illustrated in FIGS. 18A-18C, a loss curve is shown, where the loss curve is generated based on mean absolute error and an epoch.

Further, performance metrics for various demographic categories is shown in Table 1.

TABLE 1

| Category | Cells | RMSE | MAE | Mean error | Standard Deviation | Correlation |
|---|---|---|---|---|---|---|
| MU | 100 | training set: 6.124 | training set: 4.88 | 0.06 | 6.12 | 0.63 |
| | | validation Set: 6.183 | validation Set: 4.94 | | | |
| DU | 100 | training set: 6.133 | training set: 4.83 | 0.04 | 6.19 | 0.71 |
| | | validation Set: 6.718 | validation Set: 5.19 | | | |
| SU | 50 | training set: 6.67 | training set: 5.21 | 0.26 | 6.73 | 0.74 |
| | | validation Set: 7.23 | validation Set: 5.57 | | | |

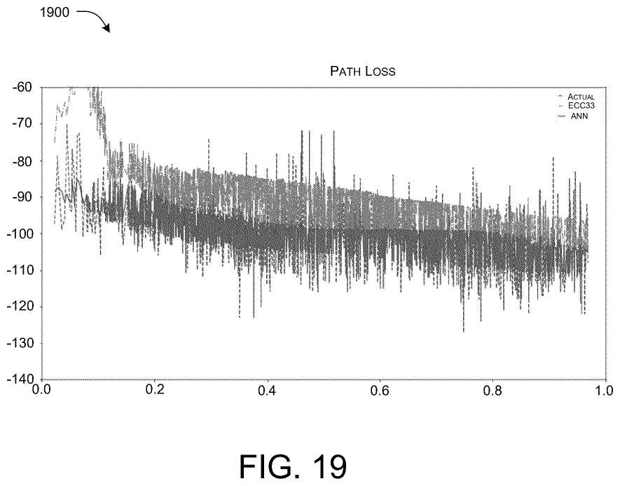

FIG. 19 illustrates an example graph (1900) representing a comparison of a predicted RSRP and an actual RSRP based on a distance for an arbitrary cell, in accordance with embodiments of the present disclosure.

As illustrated in FIG. 19, comparison between the predicted RSRP and the actual RSRP may be observed based on distance for an arbitrary cell.

Further, performance metric of the model for various demographic categories is represented in Table 2.

TABLE 2

| Category | Cells | Mean error | RMSE | MAE | Standard Deviation | Correlation |
|---|---|---|---|---|---|---|
| MU | 602 | −0.34 | 6.93 | 5.51 | 6.92 | 0.64 |
| DU | 176 | 0.06 | 6.42 | 5.06 | 6.42 | 0.69 |
| SU | 68 | −0.03 | 6.89 | 5.4 | 6.89 | 0.73 |
| Overall | 846 | 0.23 | 6.81 | 5.37 | 6.81 | 0.68 |

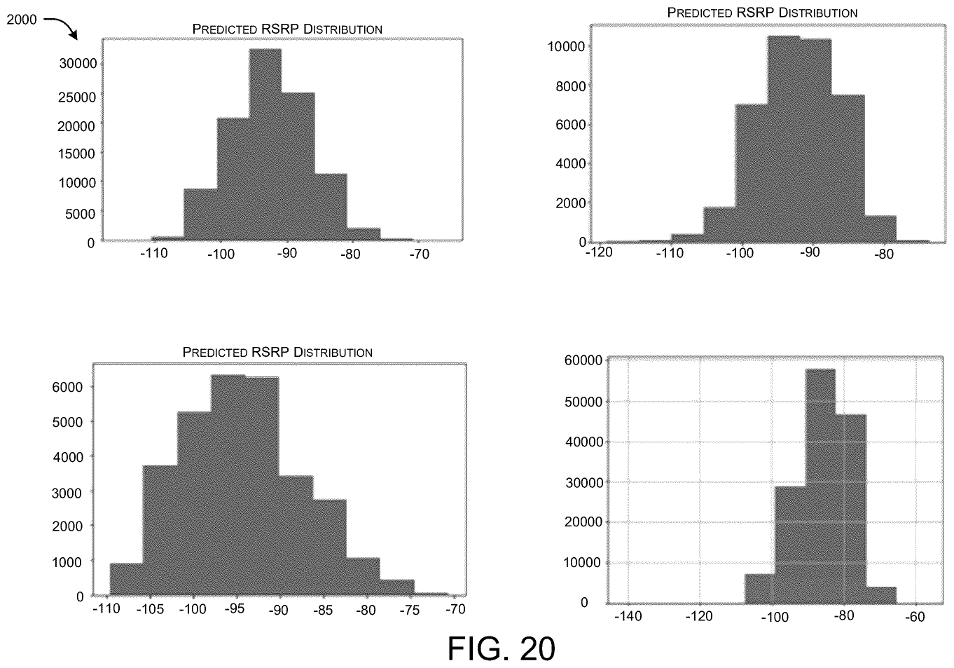

FIG. 20 illustrates an example graph (2000) representing the RSRP prediction distribution for each demographical category/grid, in accordance with embodiments of the present disclosure.

As illustrated in FIG. 20, the RSRP prediction distribution for each demographical category/grid may be observed.

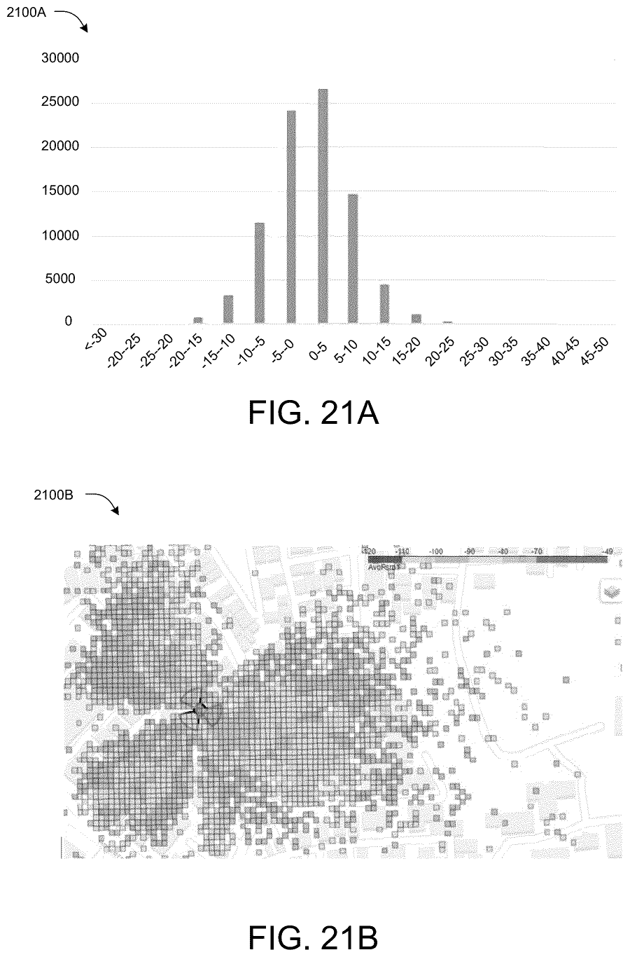

FIG. 21A-21B illustrate example representations (2100A, 2100B) of RSRP error distribution for the grids, in accordance embodiments of the present disclosure.

As illustrated in FIG. 21A-21B, the RSRP error distribution for the grids may be observed.

Further, Table 3 represents an Atoll prediction comparison based on a total number of cells, a total calculated area, a grid size, a total number of user samples, a morphology, a band, and an antenna pattern.

TABLE 3

| Parameters | | Avg | Max | Min | SD |
|---|---|---|---|---|---|
| Source Cell | Predicted | −88.14 | −76.7 | −100.3 | 4.69 |
| | RSRP | | | | |
| | Actual | −88.48 | −68.78 | −109.2 | 7.27 |
| | RSRP | | | | |
| | Atoll | −87.53 | −61 | −114 | 9.55 |
| | RSRP | | | | |
| | Predicted | 8.79 | 19.83 | −5.36 | 4.76 |
| | SINR | | | | |
| | Atoll | 15.12 | 30 | −3 | 9.39 |
| | SINR | | | | |
| N1 | Predicted | −93.1 | −77.9 | −100.4 | 5.04 |
| | RSRP | | | | |
| | Actual | −92.5 | −66 | −98.3 | 7.73 |
| | RSRP | | | | |
| | Atoll | −93.4 | −64 | −119 | 9.86 |
| | RSRP | | | | |

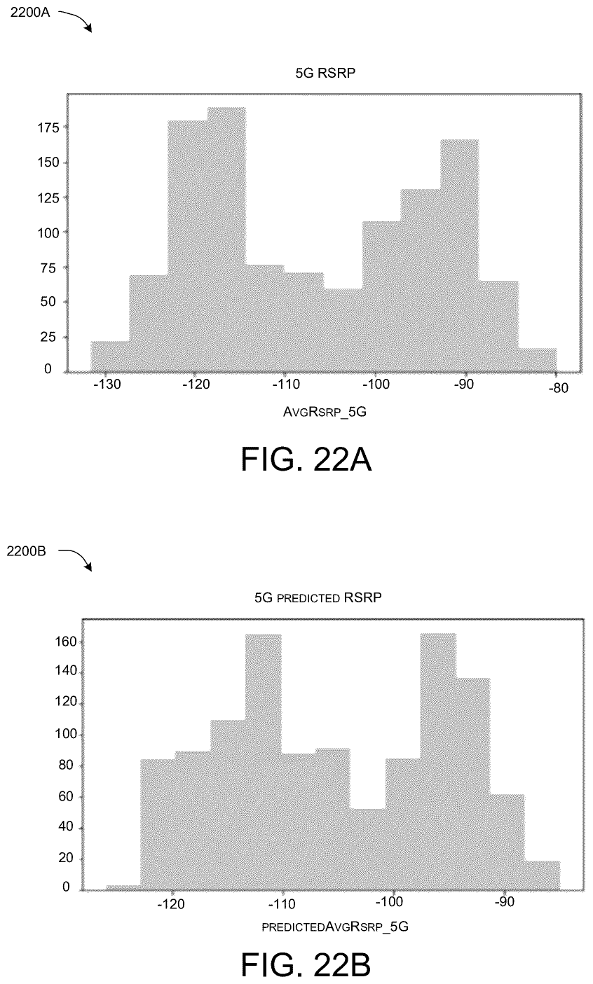

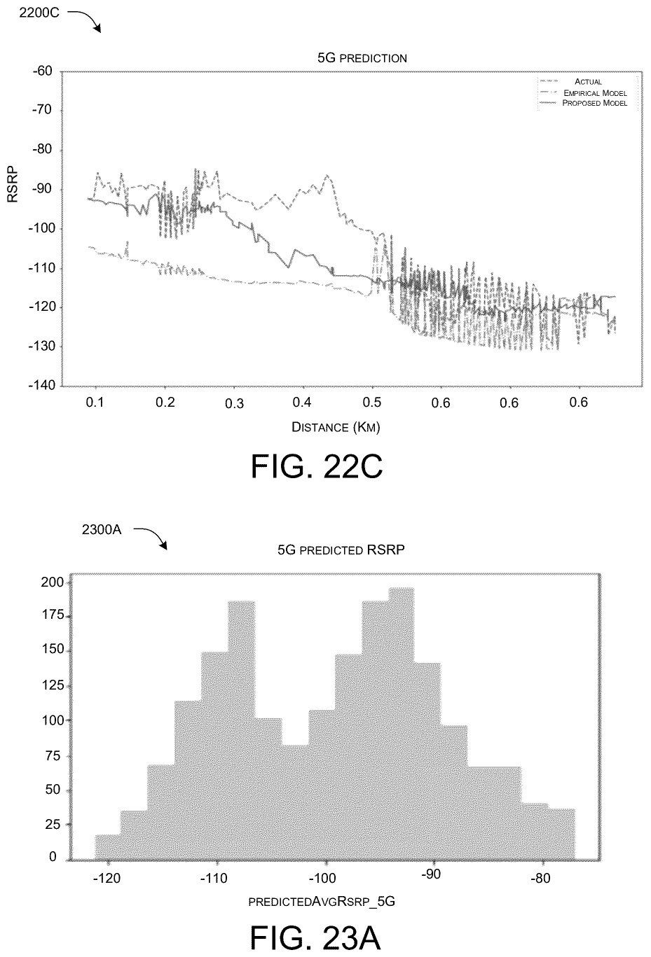

FIGS. 22A-22C illustrate example representations (2200A, 2200B, 2200C) of 5G prediction results for Hyderabad, in accordance with embodiments of the present disclosure.

As illustrated in FIG. 22A-22C, the 5G prediction results may be observed for Hyderabad.

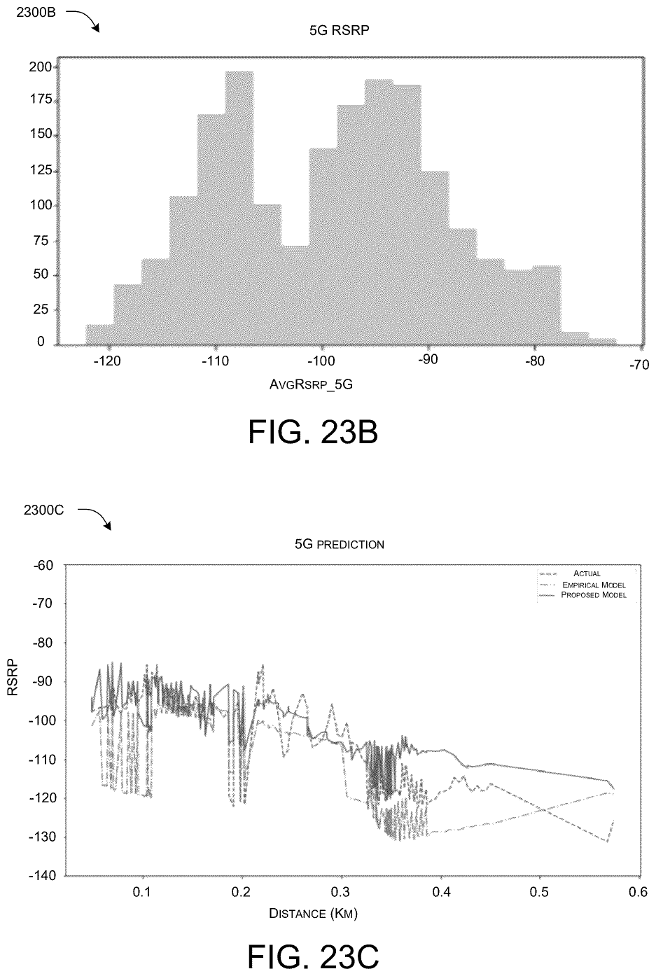

FIGS. 23A-23C illustrate example representations (2300A, 2300B, 2300C) of 5G prediction results for Chennai, in accordance with embodiments of the present disclosure.

As illustrated in FIG. 23A-23C, the 5G prediction results may be observed for Chennai.

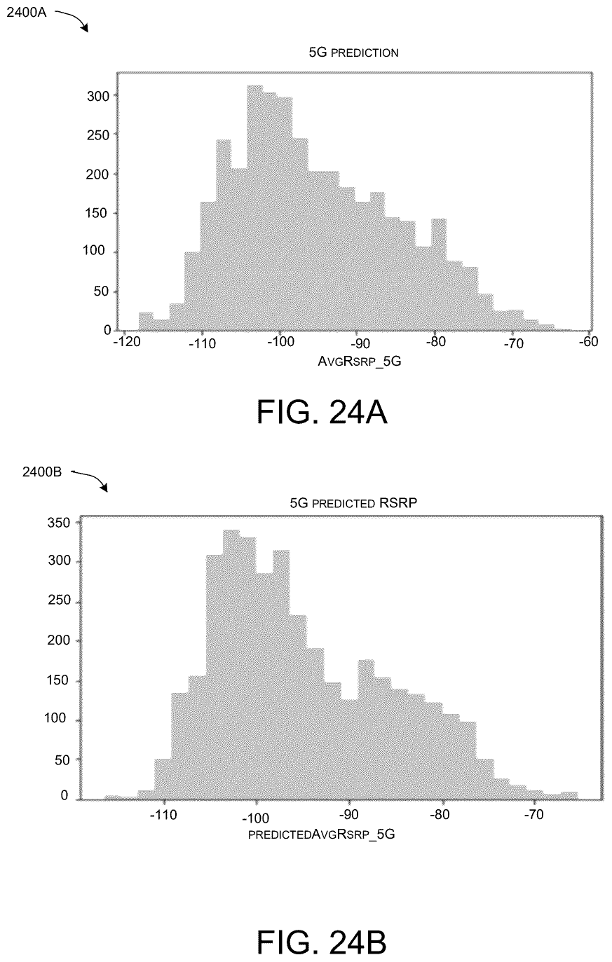

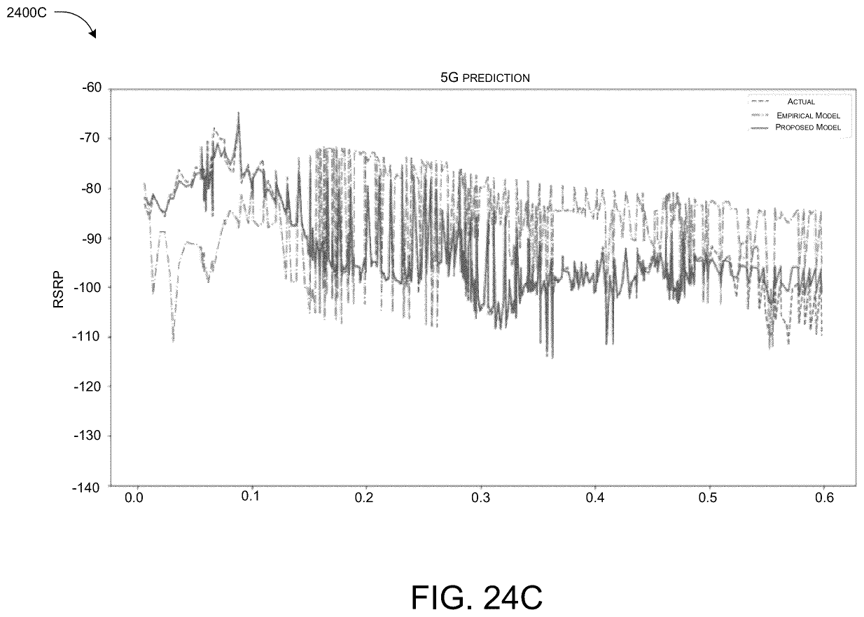

FIGS. 24A-24C illustrate example representations (2400A, 2400B, 2400C) of 5G prediction results for Ahmedabad in accordance with embodiments of the present disclosure.

As illustrated in FIG. 24A-24C, the 5G prediction results may be observed for Ahmedabad.

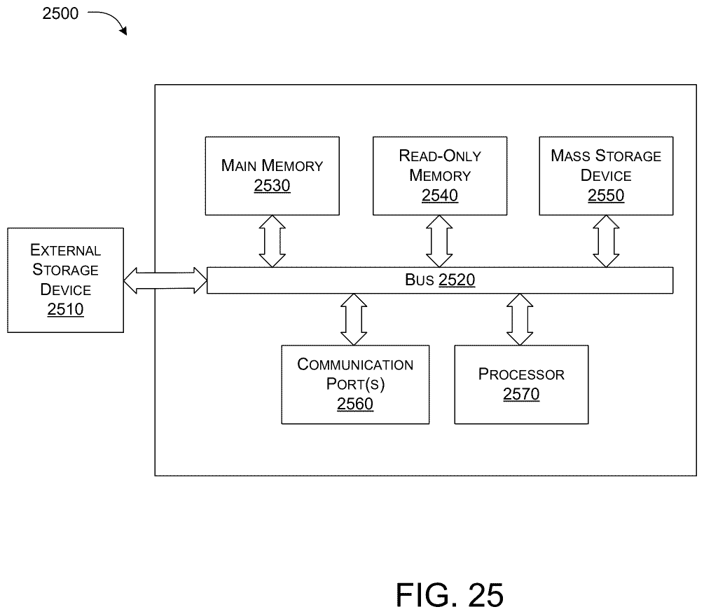

FIG. 25 illustrates an exemplary computer system (2500) in which or with which embodiments of the present disclosure may be implemented.

As shown in FIG. 25, the computer system (2500) may include an external storage device (2510), a bus (2520), a main memory (2530), a read-only memory (2540), a mass storage device (2550), a communication port(s) (2560), and a processor (2570). A person skilled in the art will appreciate that the computer system (2500) may include more than one processor and communication ports. The processor (2570) may include various modules associated with embodiments of the present disclosure. The communication port(s) (2560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (2560) may be chosen depending on a network, such as a Local Area Network (LAN), Wide Area Network (WAN), or any network to which the computer system (2500) connects.

In an embodiment, the main memory (2530) may be Random Access Memory (RAM), or any other dynamic storage device commonly known in the art. The read-only memory (2540) may be any static storage device(s) e.g., but not limited to, a Programmable Read Only Memory (PROM) chip for storing static information e.g., start-up or basic input/output system (BIOS) instructions for the processor (2570). The mass storage device (2550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (2520) may communicatively couple the processor(s) (2570) with the other memory, storage, and communication blocks. The bus (2520) may be, e.g. a Peripheral Component Interconnect PCI)/PCI Extended (PCI-X) bus, Small Computer System Interface (SCSI), (USB), or the like, for connecting expansion cards, drives, and other subsystems as well as other buses, such a front side bus (FSB), which connects the processor (2570) to the computer system (2500).

In another embodiment, operator and administrative interfaces, e.g., a display, keyboard, and cursor control device may also be coupled to the bus (2520) to support direct operator interaction with the computer system (2500). Other operator and administrative interfaces can be provided through network connections connected through the communication port(s) (2560). Components described above are meant only to exemplify various possibilities. In no way should the aforementioned exemplary computer system (2600) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that uses a machine-learning model for determining a reference signal received power (RSRP) associated with a fifth generation (5G) network which is more accurate than empirical models and provides more computational efficiency than conventional models.

The present disclosure provides a system and a method that uses the machine-learning model based on an extensive dataset to generate a flexible model architecture to make predictions.

The present disclosure provides a system and a method that uses user data with the machine learning model which is more accurate and aligned with the real world scenario.

The present disclosure provides a system and a method where a machine learning path loss model built for a fourth generation (4G) network may be used for 5G network planning in conjunction with an error correction model for frequency and antenna pattern.

The present disclosure provides a system and a method where the machine learning path loss model may be fine-tuned to achieve higher accuracy of performance metrics.

1. A system for estimating a path loss propagation model, the system comprising:
a processor; and
a memory operatively coupled with the processor, wherein said memory stores instructions, which when executed by the processor, cause the processor to:
receive one or more data parameters associated with a primary network, wherein the one or more data parameters are based on a network configuration of the primary network;
predict, via a trained learning model, a reference signal received power (RSRP) associated with the primary network based on the one or more data parameters, wherein the trained learning model is based on a trained secondary network model;
receive one or more user parameters, wherein the one or more user parameters are based on an actual RSRP received from a computing device connected to the primary network;
generate, via an error correction model, an error estimation based on the predicted RSRP and the actual RSRP; and
determine an estimated RSRP associated with the primary network based on the error estimation.

2. The system as claimed in claim 1, wherein the one or more data parameters comprise at least one of: a frequency, one or more physical parameters, and an antenna pattern associated with the primary network.

3. The system as claimed in claim 1, wherein the processor is to use a Naïve RSRP prediction technique to predict the RSRP.

4. The system as claimed in claim 1, wherein the one or more user parameters comprise at least one of: a label switch router (LSR) data, a Latitude data, a Longitude data, one or more radio frequency parameters, and a device configuration data.

5. The system as claimed in claim 1, wherein the processor is to generate, via the error correction model, an optimized model, and wherein the optimized model is based on a variance between the predicted RSRP and the actual RSRP.

6. The system as claimed in claim 1, wherein the processor is to use a Random Forest technique to generate the error estimation.

7. The system as claimed in claim 1, wherein the trained secondary network model used by the processor is configured to:
receive one or more secondary data parameters associated with a secondary network, wherein the one or more secondary data parameters are based on a network configuration for the secondary network;
predict, via a secondary learning model, an RSRP associated with the secondary network based on the one or more secondary data parameters;
receive one or more secondary user parameters, wherein the one or more secondary user parameters are based on an actual RSRP received from another computing device connected to the secondary network;
determine an average RSRP based on the received one or more secondary user parameters and one or more predetermined geographical frameworks associated with the another computing device connected to the secondary network;
identify one or more computing devices among the one or more predetermined geographical frameworks connected to the secondary network;
generate a total average RSRP based on the average RSRP and an RSRP associated with the identified one or more computing devices; and
generate, via a machine learning technique, a secondary error correction model based on the total average RSRP and the predicted RSRP.

8. The system as claimed in claim 7, wherein the secondary error correction model is configured to:
receive the one or more secondary user parameters and generate an activation function to compute a measured RSRP based on the one or more secondary user parameters and the total average RSRP; and
compute the activation function using an average regularized gradient such that a difference between the predicted RSRP and the measured RSRP is zero.

9. The system as claimed in claim 7, wherein the machine learning technique is an Artificial Neural Network (ANN) technique.

10. The system as claimed in claim 7, wherein the one or more predetermined geographical frameworks comprise at least a geographical area associated with the another computing device and a topography mapping associated with said at least geographical area.

11. A method for estimating a path loss propagation model, the method comprising:
receiving, by a processor associated with a system, one or more data parameters associated with a primary network, wherein the one or more data parameters are based on a network configuration of the primary network;
predicting, by the processor, via a trained learning model, a reference signal received power (RSRP) associated with the primary network based on the one or more data parameters, wherein the trained learning model is based on a trained secondary network model;
receiving, by the processor, one or more user parameters, wherein the one or more user parameters are based on an actual RSRP received from a computing device connected to the primary network;
generating, by the processor, via an error correction model, an error estimation based on the predicted RSRP and the actual RSRP; and
determining, by the processor, an estimated RSRP associated with the primary network based on the error estimation.

12. The method as claimed in claim 11, wherein the one or more data parameters comprise at least one of: a frequency, one or more physical parameters, and an antenna pattern associated with the primary network.

13. The method as claimed in claim 11, comprising using, by the processor, a Naïve RSRP prediction technique to predict the RSRP.

14. The method as claimed in claim 11, wherein the one or more user parameters comprise at least one of: a label switch router (LSR) data, a Latitude data, a Longitude data, one or more radio frequency parameters, and a device configuration data.

15. The method as claimed in claim 11, comprising generating, by the processor, via the error correction model, an optimized model, wherein the optimized model is based on a variance between the predicted RSRP and the actual RSRP.

16. The method as claimed in claim 11, comprising using, by the processor, a Random Forest technique to generate the error estimation.

17. A non-transitory computer readable medium comprising a processor with executable instructions, causing the processor to:
receive one or more data parameters associated with a primary network, wherein the one or more data parameters are based on a network configuration of the primary network;
predict, via a trained learning model, a reference signal received power (RSRP) associated with the primary network based on the one or more data parameters, wherein the trained learning model is based on a trained secondary network model;
receive one or more user parameters, wherein the one or more user parameters are based on an actual RSRP received from a computing device connected to the primary network;
generate, via an error correction model, an error estimation based on the predicted RSRP and the actual RSRP; and
determine an estimated RSRP associated with the primary network based on the error estimation.
